(19) United States
(12) Patent Application Publication
(10) Pub. No.: US 2017/0000285 A1
(43) Pub. Date: Jan. 5, 2017

(54) COFFEE PRESS

(71) Applicant: LIFETIME BRANDS, INC., Garden City, NY (US)

(72) Inventors: Armando Martija, Brooklyn, NY (US); Lindsay Randall, Queens, NY (US)

(73) Assignee: LIFETIME BRANDS, INC., Garden City, NY (US)

(21) Appl. No.: 14/914,022

(22) PCT Filed: Oct. 1, 2015
(86) PCT No.: PCT/US15/53440

§ 371 Date: Feb. 24, 2016

Related U.S. Application Data
(60) Provisional application No. 62/059,202, filed on Oct. 3, 2014.

(51) Int. Cl. A47J 31/38; A47J 31/18

(52) U.S. Cl. CPC A47J 31/38; A47J 31/18

(57) ABSTRACT

A French press coffee maker having a carafe with a removable bottom portion is disclosed. The bottom of the carafe is open and a bottom portion is removably secured to the open bottom of the same. A seal ring is positioned between the bottom portion and the open bottom of the carafe to provide a liquid tight seal once connected. In this manner, cleaning the device is made easier and simpler by maintaining enabling the removal of the user coffee grounds from the bottom of the carafe.

### CROSS REFERENCE TO RELATED APPLICATIONS

This application claims priority from U.S. Provisional Application Ser. No. 62/059,202 filed on Oct. 3, 2014.

### BACKGROUND

Technical Field

The present invention relates to coffee makers. More particularly, it relates to the incorporation of a removable bottom portion to the carafe of a French press coffee maker.

Description of the Related Art

The use of coffee maker known as a French Presses commonly known. It is well known to use French press coffee makers to “steep” coffee. Namely, boiling water is mixed with coarsely ground coffee in a container or carafe. After the coffee is allowed to steep for several minutes, one presses down on a handle, thus containing the grounds in the bottom of the container beneath a perforated disk. The disk is perforated allows the liquid coffee to pass through the disk as the disk is being lowered through the liquid. The coffee can then be poured (or drunk directly) from the container while the grounds are prevented from flowing out of the container.

One primary disadvantage to the current designs of French presses is when it comes time to clean the same. Although the grounds are compressed at the bottom of the press, they are loose at the bottom of the carafe and need to be removed from the bottom after brewing. This removal process is difficult and tedious, and often deters individuals from wanting to use the French press at all.

It would therefore be desirable to have a French Press design that allows for easy removal of the grounds, and therefore easier cleaning and ultimate use of the same.

### SUMMARY

The present principles provide a French press coffee maker having a removable bottom portion. Once use is complete (i.e., the grounds have been pressed to the bottom of the carafe and the coffee dispensed as desired, the bottom can be removed to remove the pressed coffee grounds, and thus make cleaning of the coffee maker as simple as possible.

According to one embodiment, the coffee press includes a carafe having an open bottom and a lid, a press mechanism passing through the lid, and a bottom portion that is configured to be removably attached to the open bottom of the carafe.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 shows a cross-sectional view of the French Press coffee maker with a removable bottom portion, according to one implementation of the present principles;

FIGS. 2 and 3 show exploded perspective views of the French Press coffee maker with removable bottom portion, and the removable bottom portion, respectively, according to an implementation of the present principles; and

FIGS. 4-11 show the details of the various parts of the French Press Coffee Maker and more specifically the parts that make up one embodiment of the press with removable bottom portion.

### DETAILED DESCRIPTION

Before describing the figures in detail, applicant points out that the measurements, angles and all other specific indicia included in the drawings are for exemplary purposes only and are not in any way meant to limit the respective parts and their configurations. Changes in these indicia can be implemented without departing from the intended scope of this disclosure.

The following is a general list of parts and reference numerals for ease of reference:

1—Decorative sleeve;

2—press bottom half;

3—press top half;

4—silicone press ring;

5—press mesh;

6—plastic lid insert;

7—metal lid;

8—finial bottom;

9—finial nut;

10—finial top;

11—center or push rod;

12—glass carafe/container;

13—screw bottom;

14—bottom seal (O-ring);

15—metal cover for screw bottom;

16—lid nut;

17—metal handle; and

18—lid screw.

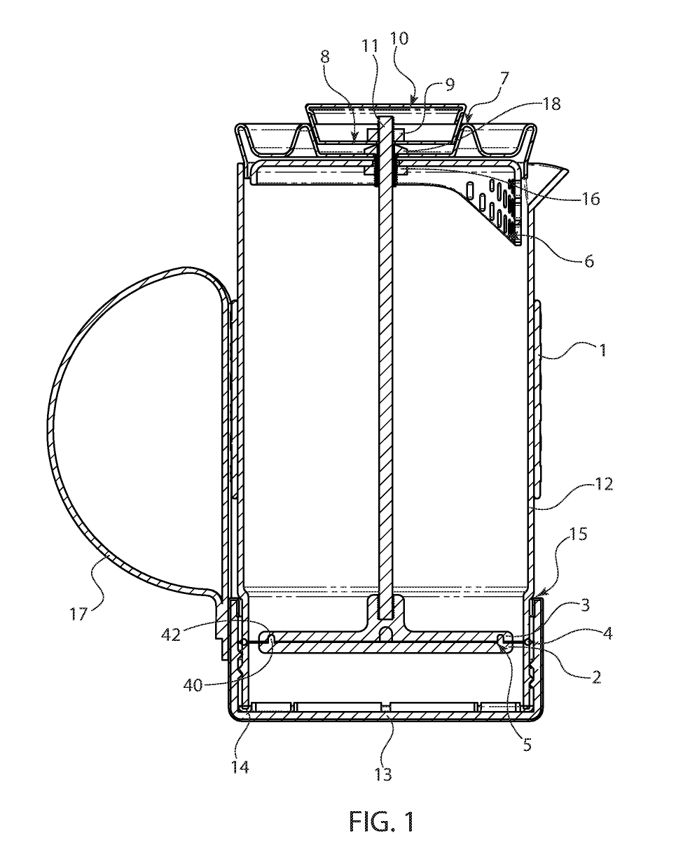

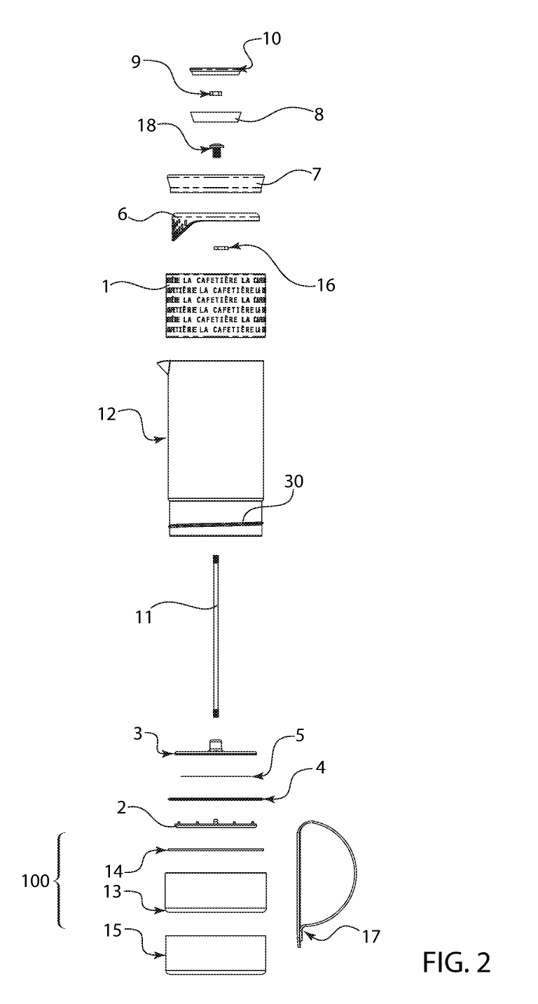

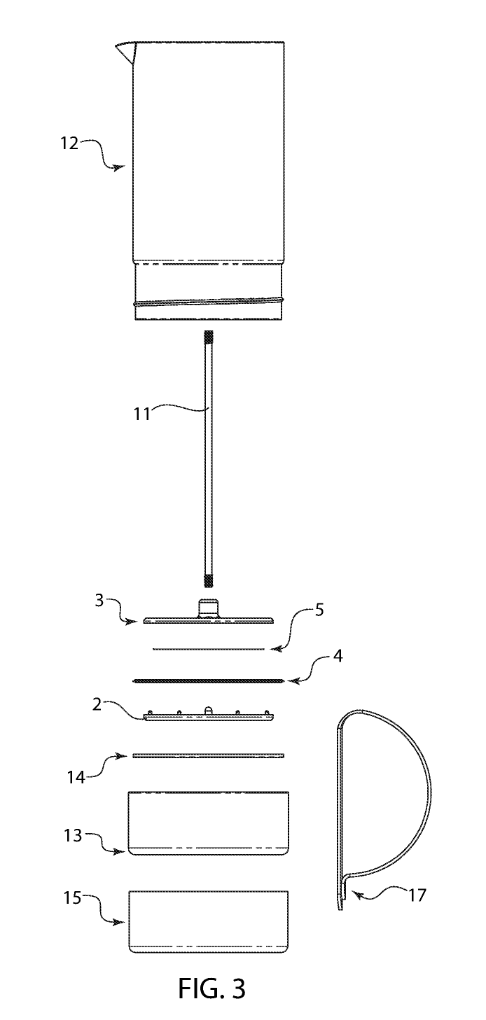

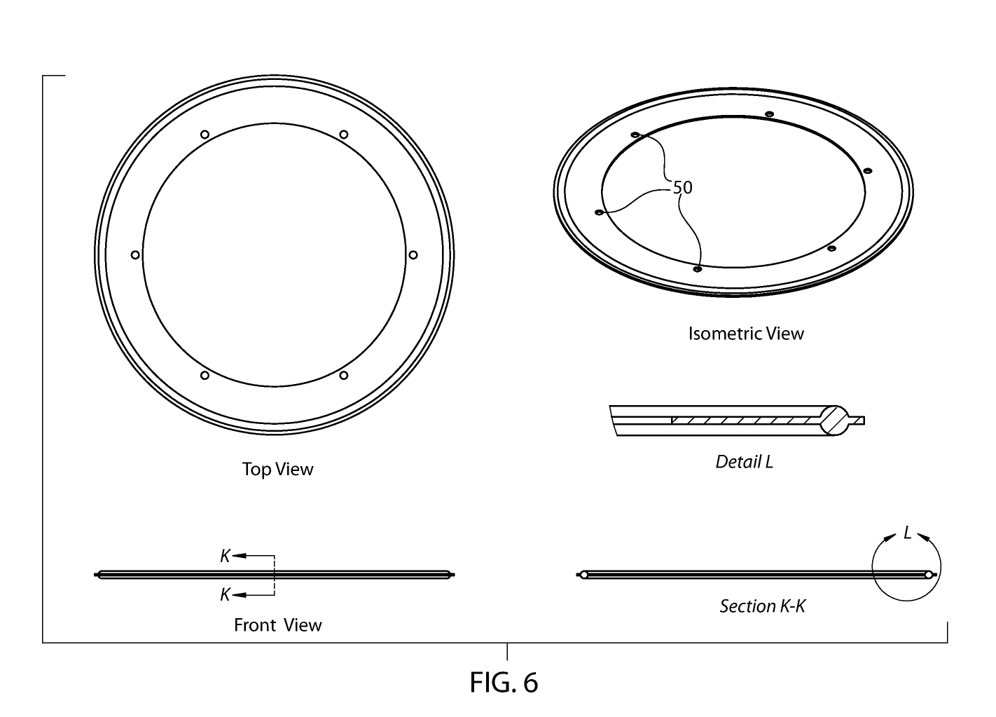

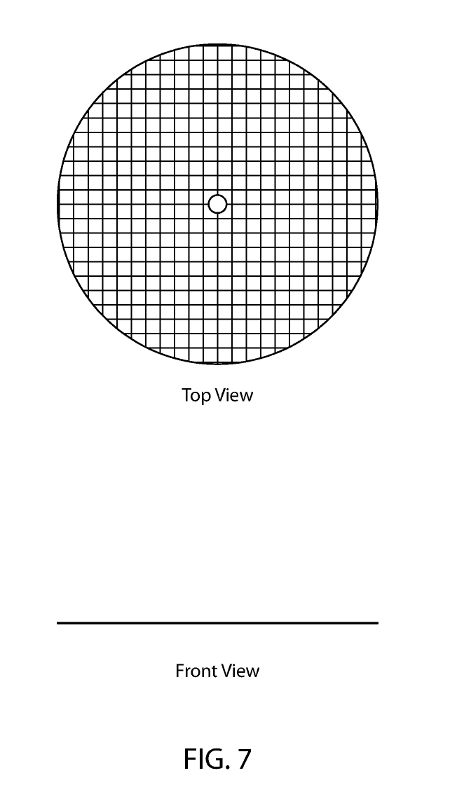

FIGS. 1-3 shows a cross sectional view of a French press coffee maker in accordance with the present principles. The press rod 11 is connected to a press formed by an upper or top half 3 and a lower or bottom half 2. Sandwiched between the two halves 2 and 3 is a mesh grid 5 (FIG. 7) and a silicon ring 4 (FIG. 6). The connection between the upper half 3 and the lower half 2 can be performed with any known connection mechanism. As shown, a plurality of protrusions 40 can be positioned around the upper surface of the lower half 2 with corresponding receiving holes 42 in the underside of the upper half 3, such that a friction fit between the two parts operates to secure them together while retaining mesh portion 5 and silicon ring 4 sandwiched there between. A central protrusion 46 can assist in proper positioning of the upper half 3 with respect to lower half 2, and will be received by a hole 46 in the upper half 3.

Those of skill in the art will appreciate that the connection mechanism between upper half 3 and lower half 2 can be achieved in many different ways, include, but not limited to a mechanical latch system.

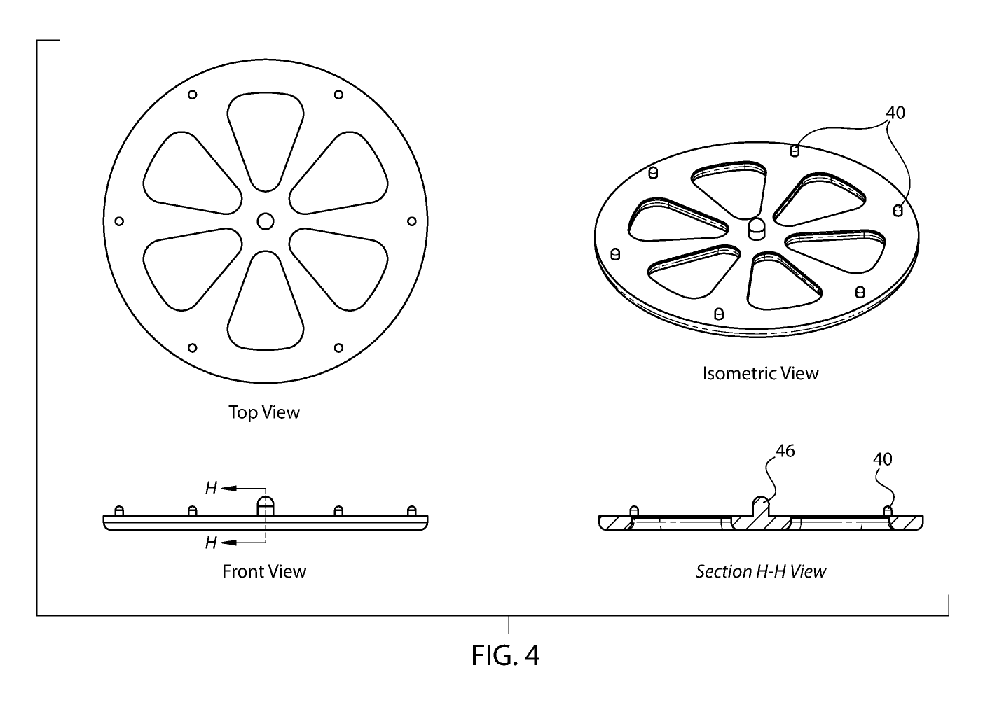

As mentioned above, the silicone ring 4 is also secured between the upper half 3 and the lower half 2 of the press such that the circumference of the same is in contact with the side walls of the carafe 12 and maintains a seal with the same. The silicone ring 4 can include openings 50 (FIG. 6) that are aligned with the protrusions 40 (FIG. 4) in the lower half 2 such that the same does not shift or move once sandwiched between the upper or top half 3 and lower or bottom half 2. A cross section example of one preferred implementation of the silicon ring 4 is shown in FIG. 6 (Detail L).

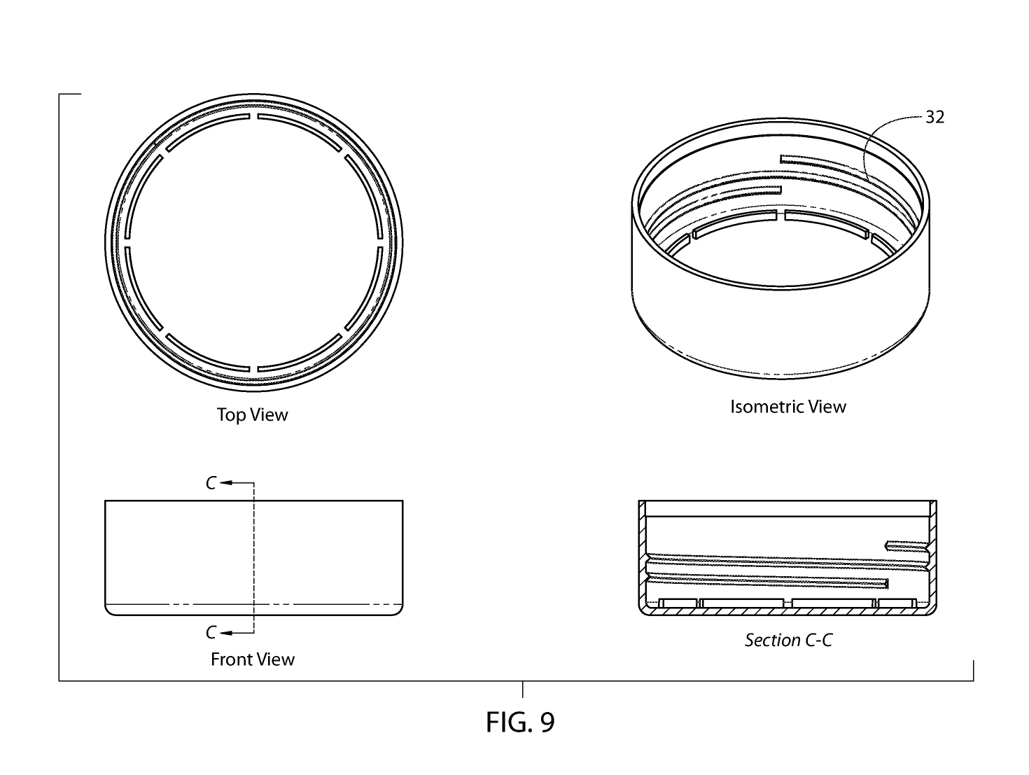

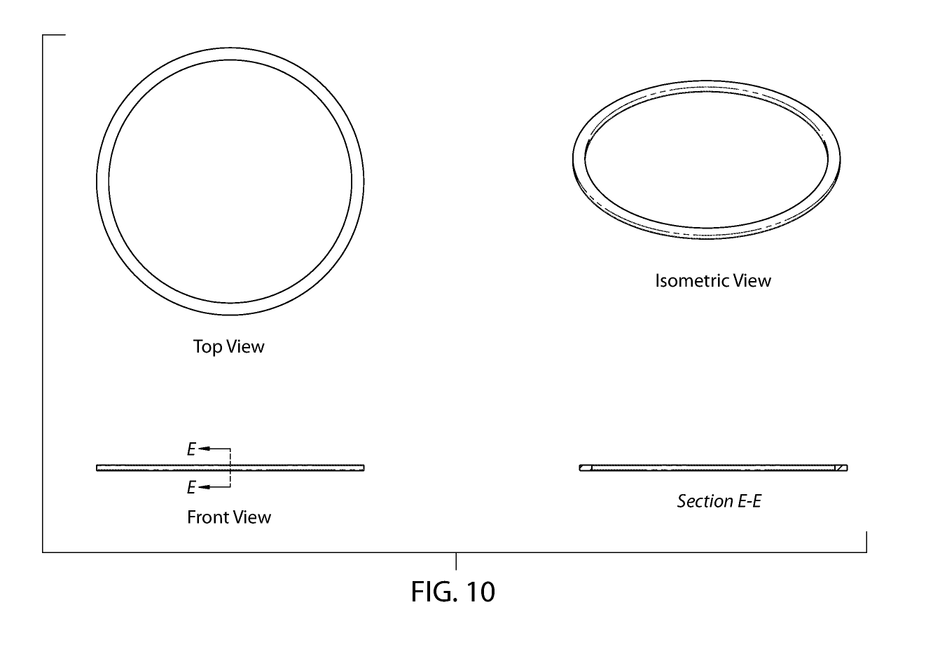

As shown in FIGS. 1-3, the removable bottom portion 100 is made up of a screw bottom 13 (FIG. 9 and a bottom seal or O-ring 14 (FIG. 10). The Carafe 12 is essentially a cylinder having an open bottom which includes a threaded portion 30 on an exterior surface thereof and which is configured to match with a threaded portion 32 on the inner surface of the screw bottom 13. (See FIG. 9). A seal ring 14 (e.g. O-ring) is disposed at the bottom of the screw bottom 13 such that when the screw bottom is screwed onto to bottom of the carafe 12, the seal 14 contacts and liquid tight seals the entire circumference of the bottom of carafe 12 (See FIG. 1). In another implementation, a decorative metal cover 15 can be positioned over the screw bottom so as to provide additional integrity or strength to the bottom, and/or to insulate the same so that when filled with boiling water, the heat transfer from the screw bottom to the exterior surface of the same is minimized.

Once the French press with removable bottom 100 is assembled as described above, the use of the same is essentially identical to that of known French press coffee makers. The difference is when it comes time to clean the same. Once use of the press is complete, the screw bottom 13 is unscrewed and any and all coffee grounds that have been pressed into the bottom are easily removed from the same. The carafe 12, the screw bottom 13, and all other parts are now easily cleaned.

Those of skill in the art will appreciated that although removable bottom portion 13 and corresponding lower portion of carafe 12 are shown with threaded connections, other types of connections could be implemented without departing from the intended scope of the invention. For example, a mechanical latch system could be integrated into either or both parts.

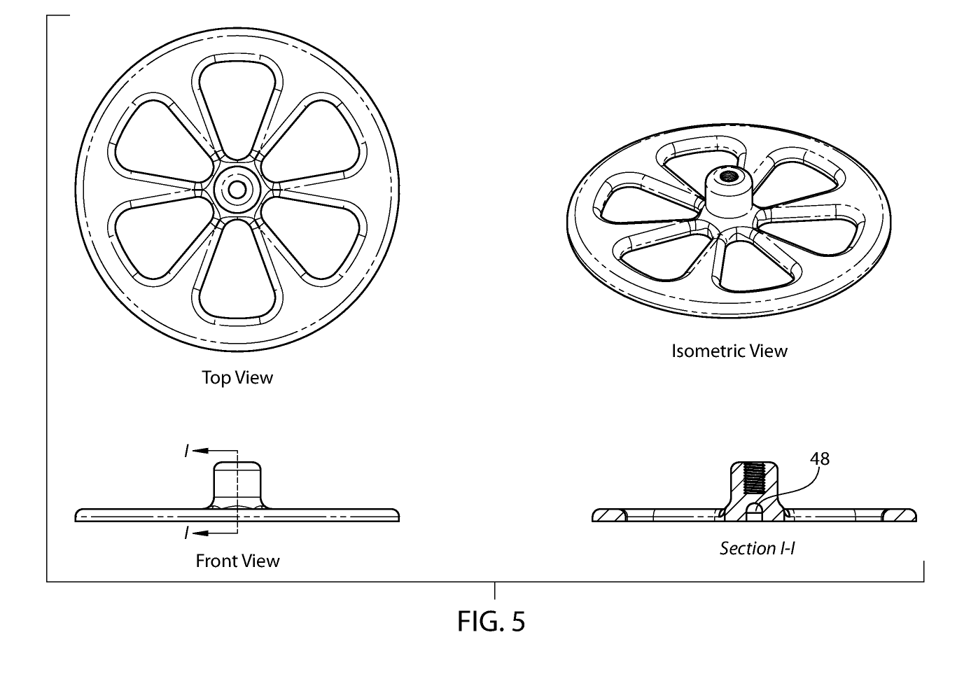

FIG. 4 shows the lower half 2 of the press according to one implementation of the present principles. FIG. 5 shows the upper half 3 of the press according to one implementation of the present principles. FIG. 6 shows the silicone ring 4 according to an implementation of the present principles.

The mesh part 5 has micron sized openings which cannot be easily depicted in the drawings shown. FIG. 7 shows a magnified view of the mesh part 5 in an effort to show the same. Those of skill in the art of coffee makers such as these will appreciate that the micron size can be varied so long as the same is sufficiently small to prevent the passing of coffee grounds from the basket into the water (i.e., coffee being dispensed). Mesh 5 is generally made of a stainless steel metal foil having a micron sized mesh (e.g., 600 microns) and which, under pressure, could be crushed or deformed, which is the primary reason for its position between parts 3 and 4 in a sandwiched configuration.

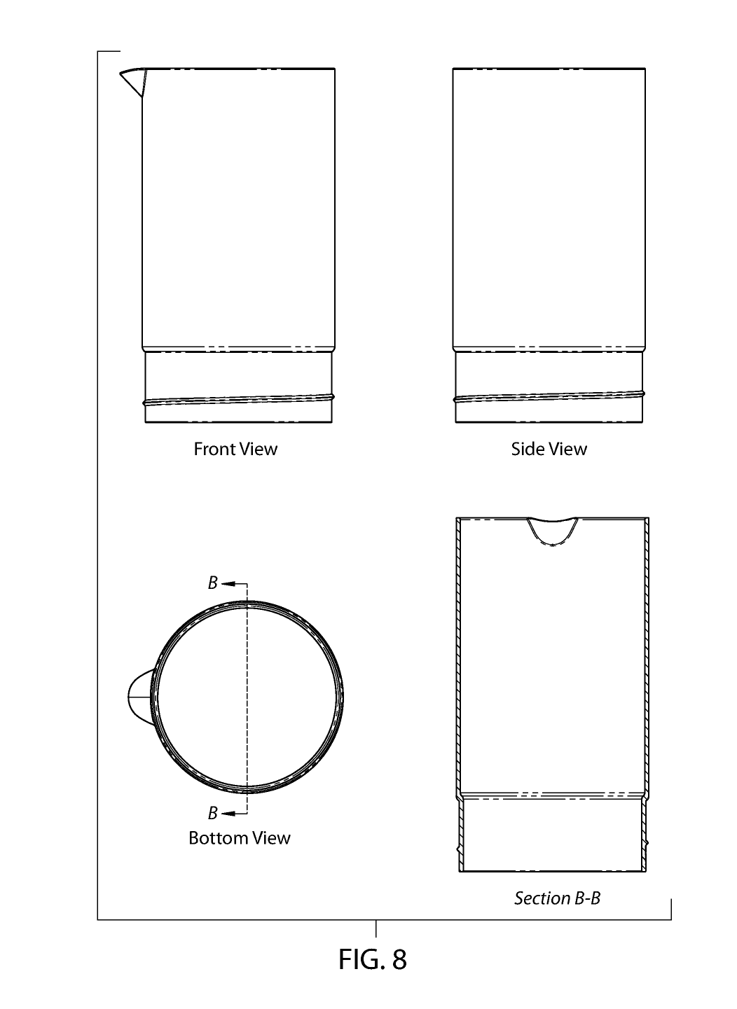

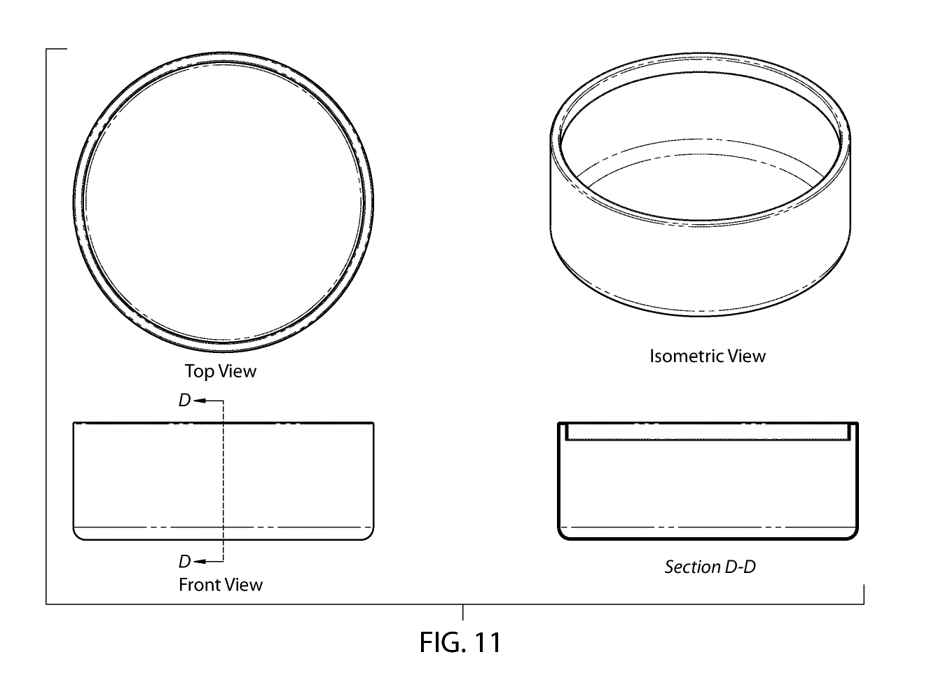

FIG. 8 shows the carafe 12 according to an implementation of the present principles. FIG. 9 shows the screw bottom 13 according to an implementation of the present principles. FIG. 10 shows the sealing or O-ring 14 according to an implementation of the present principles. FIG. 11 is an example of a metal cover 15 according to an implementation of the present principles.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

1. A coffee press comprising:
a carafe comprising an upper portion having an open bottom and a lower portion removably attached to the open bottom; and
a press mechanism passing through a lid and configured to operate in a hand driven longitudinal motion though said upper portion and into said lower portion of the carafe.

2. The coffee press according to claim 1, wherein said upper portion of said carafe comprises a threaded portion on an exterior surface adjacent the open bottom, and said lower portion comprises:
an internal thread configured to mate with the threaded portion on the carafe; and
a sealing ring positioned at a bottom of the bottom portion and configured to create a liquid tight seal between the open bottom of the carafe and the bottom portion when attached to the same.

3. The coffee press according to claim 2, wherein said press mechanism comprises a rod extending through the carafe and having a distal end, and a press bottom connected to the distal end, said press bottom comprising:
a press top half connected to the rod;
a press bottom half configured to be connected to the press top half;
a mesh screen sandwiched between the press bottom half and press top half; and
a sealing ring configured to seal the press bottom against interior side surfaces of the carafe.

4. A coffee press comprising:
a carafe having an open bottom and a lid;
a press mechanism passing through the lid and the carafe; and
a bottom portion threadably connected to the open bottom of the carafe.

5. The coffee press according to claim 4, further comprising a sealing ring positioned at a bottom of the bottom portion and configured to create a liquid tight seal between the open bottom of the carafe and the bottom portion when attached to the same.

6. The coffee press according to claim 4, wherein said press mechanism comprises a rod extending through the lid and having a distal end, and a press bottom connected to the distal end of the rod, said press bottom comprising:
a press top half connected to the rod;
a press bottom half configured to be connected to the press top half;
a mesh screen sandwiched between the press bottom half and press top half; and
a sealing ring configured to seal the press bottom against interior side surfaces of the carafe.

7. The coffee press according to claim 3, wherein the sealing ring is configured to seal against internal side walls of the carafe such that the sides and bottom of the press mechanism are sealed from liquid communication with an upper portion of the carafe during a downward press action of the rod.

8. The coffee press according to claim 6, wherein the sealing ring is configured to seal against internal side walls of the carafe such that the sides and bottom of the press mechanism are sealed from liquid communication with an upper portion of the carafe during a downward press action of the rod.
